(19) United States
(12) Patent Application Publication
(10) Pub. No.: US 2015/0277824 A1
(43) Pub. Date: Oct. 1, 2015

(54) IMAGE FORMING APPARATUS, PRINT CONTROL METHOD AND STORAGE MEDIUM STORING PROGRAM

(71) Applicant: CANON KABUSHIKI KAISHA, Tokyo (JP)

(72) Inventor: Junichi Hiruma, Hidaka-shi (JP)

(21) Appl. No.: 14/665,183

(22) Filed: Mar. 23, 2015

(30) Foreign Application Priority Data
Apr. 1, 2014 (JP) 2014-075725

(51) Int. Cl. G06F 3/12; G06K 15/00

(52) U.S. Cl. CPC G06F 3/1238; G06K 15/4095; G06F 3/1204; G06F 3/1222; G06F 3/1273; G06F 3/126

(57) ABSTRACT

If user information of a login user is acquired, it is determined whether or not a permission to execute a print job for an administrator for printing print information for an administrator is given to the user information. If it is determined that the permission is given, the print job for an administrator is executed to print the print information for an administrator.

### BACKGROUND OF THE INVENTION

1. Field of the Invention

The present invention relates to an image forming apparatus that prints a print job, a print control method and a storage medium storing a program.

2. Description of the Related Art

Conventionally, multifunctional peripherals (MFP) that provide a copy service including a scanner function and a printer function, a transmission/reception service that transmits and receives email and fax, a network print service and the like are known. Such an MFP has a report function that accumulates services that have already been carried out in the MFP as job history and prints the accumulated job history onto printing paper. In particular, a printout obtained by printing the job history of the transmission/reception service by using the report function is called a “communication management report”. On the communication management report, confidential information such as the date and time of jobs executed, transmission/reception results, and transmission destination addresses is printed.

Generally, printing of the communication management report can be performed through designation of an “auto-communication management report function” as disclosed in Japanese Patent Laid-Open Nos. 2010-130509 and 2003-78678. The “auto-communication management report function” refers to a function that automatically discharges a communication management report to a tray if a predetermined number of unprinted job history entries are accumulated. For example, it is determined whether a predetermined number of job history entries (for example, 100 entries) not output onto a communication management report have been accumulated. Then, the non-output job history entries are printed as a communication management report, and the communication management report is discharged to a tray.

The “auto-communication management report function” is generally a function targeted for an administrator, and thus the administrator determines whether or not to enable the function. Then, the administrator checks whether a communication management report has been discharged on a tray, and then files the collected communication management report and manages the communication management report.

Meanwhile, the MFP determines, with the use of a login authentication function, whether the user is permitted to use the MFP. The MFP prompts the user to input authentication information such as user name and password, and checks whether the input information matches the information registered in the MFP. If it is determined that the input information matches the registered information, the MFP permits the user who input the authentication information to use the MFP.

As disclosed in Japanese Patent Laid-Open No. 2003-345755, from the view point of managing the MFP, the user permitted to use the MFP by the login authentication function is classified as either “administrator” or “general user”. The user permitted to use the MFP with administrative rights by the login authentication function is authorized to make changes in the time setting, the management of MFP users, the network settings, and the equipment settings including device management such as a power source. Because the equipment settings do not need to be frequently changed, it is often the case that the administrator performs both general tasks and management tasks including managing the equipment settings and collecting the communication management report. If the administrator is busy with performing general tasks, he/she may ask another reliable person to collect the communication management report discharged on the tray.

The MFP cannot provide services if there is an error in the equipment settings made by the administrator. The management tasks performed by the administrator after logging in require very heavy responsibility, and thus no error is allowed. Accordingly, in order to avoid an unnecessary risk of making an error in the equipment settings, the administrator prepares authentication information that does not provide administrative rights, and logs into the MFP with the prepared authentication information without using the administrative rights unless it is necessary to perform management tasks such as changing values in the equipment settings. That is, the administrator possesses authentication information that provides administrative rights and authentication information that does not provide administrative rights, and when it is unnecessary to perform management tasks, the administrator uses the MFP by logging in with the use of the authentication information that does not provide administrative rights, in order to prevent unintended changes in the equipment settings.

A way for the administrator to know that a predetermined number of jobs of the transmission/reception service have been executed is to be aware of the communication management report discharged on the tray. However, the communication management report is not the only printout discharged onto the tray. There may be, for example, printouts that have been automatically discharged by the network print service requested from a PC on the tray. Accordingly, there is a possibility that the communication management report might be mixed up with and embedded in various printouts on the tray. In this case, the administrator has to look for the communication management report embedded in the printouts on the tray.

Also, the communication management report is discharged when a predetermined number of jobs of the transmission/reception service have been carried out, and thus the date and time at which the communication management report is discharged is not pre-set. Accordingly, it is not possible for the administrator to know when the communication management report was discharged or when the communication management report needs to be collected. This situation also creates a security problem in that the communication management report left on the tray may be viewed by people other than the administrator. In view of the above, there is a demand for reducing the time during which the communication management report is left on the tray as much as possible and collecting the communication management report immediately after discharged onto the tray.

### SUMMARY OF THE INVENTION

An aspect of the present invention is to eliminate the above-mentioned problems with the conventional technology. The present invention provides an image forming apparatus that improves collection efficiency of collecting printouts for an administrator as to maintain security for the printouts, a print control method, and a storage medium storing a program.

The present invention in one aspect provides an image forming apparatus comprising: an acquiring unit configured to acquire user information of a login user; a determining unit configured to, in a case where the user information is acquired by the acquiring unit, determine whether or not a permission to execute a print job for an administrator for printing print information for an administrator is given to the user information; and a print unit configured to, in a case where it is determined by the determining unit that the permission is given, execute the print job for an administrator so as to print the print information for an administrator.

According to the present invention, it is possible to improve collection efficiency of collecting printouts for an administrator as to maintain security for the printouts.

Further features of the present invention will become apparent from the following description of exemplary embodiments with reference to the attached drawings.

### BRIEF DESCRIPTION OF THE DRAWINGS

FIGS. 1A and 1B are diagrams showing a configuration of an MFP.

FIG. 2 is a diagram showing a block configuration for managing job history.

FIG. 3 is a diagram showing a communication management report.

FIG. 4 is a diagram showing a communication management report printing method selection screen.

FIG. 5 is a diagram showing a reserved print job management screen.

FIG. 6 is a flowchart illustrating processing of the communication management report.

FIG. 7 is a diagram showing a login management table.

FIG. 8 is a diagram showing a screen for receiving an instruction to print reserved communication management report jobs.

FIG. 9 is a flowchart illustrating print processing for printing the reserved communication management report job.

FIG. 10 is a diagram showing a general user registration screen.

FIG. 11 is a diagram showing a general user confirmation screen.

FIG. 12 is a diagram showing a general user table.

FIG. 13 is a diagram showing a communication management report collector setting screen.

FIGS. 14A and 14B are diagrams each showing a list of rights to use the functions provided by the MFP.

FIGS. 15A and 15B are diagrams each showing a list of rights to use the functions provided by the MFP.

FIGS. 16A and 16B are flowcharts illustrating registration processing for registering a general user.

FIG. 17 is a flowchart illustrating processing for printing a communication management report.

FIGS. 18A and 18B are flowcharts illustrating processing for determining a general user.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same constituent elements are given the same reference numerals, and a description thereof is omitted.

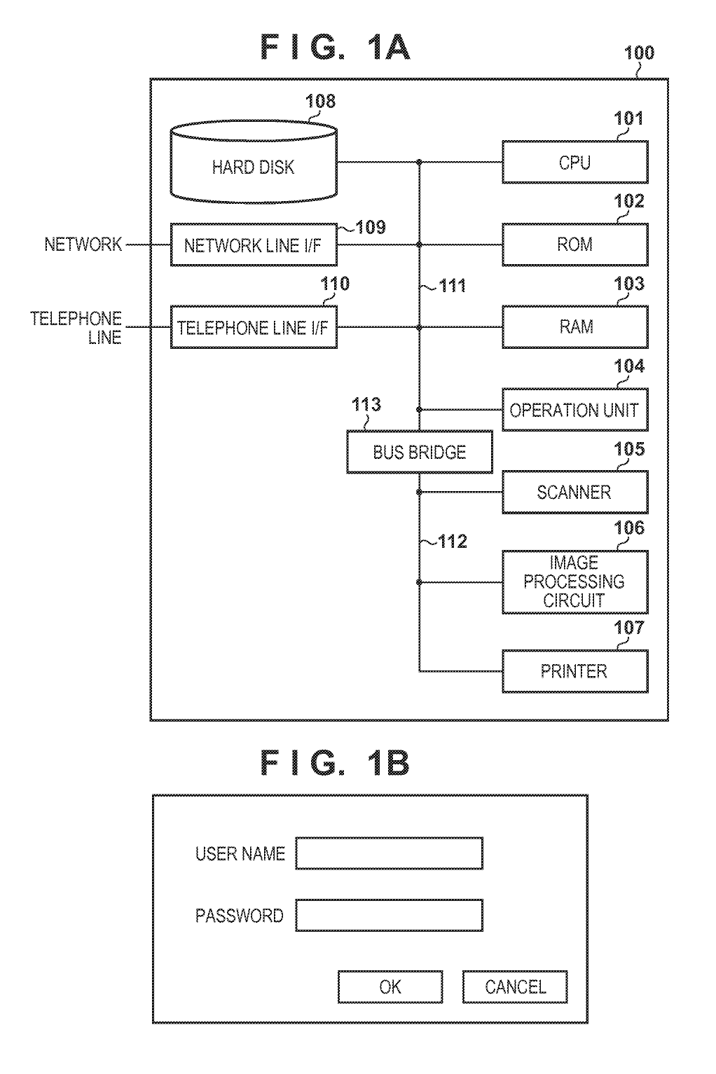

FIGS. 1A and 1B are diagrams showing a configuration of an MFP 100 used as an example of an image forming apparatus in the present embodiment. The MFP 100 shown in FIG. 1A is a multifunctional peripheral collectively having a plurality of functions such as a scan function, a print function and a fax function. A CPU 101 performs overall control on the MFP 100 by reading a program stored in a ROM 102 into a RAM 103 and executing the program. An operation unit 104 includes a display unit such as an LCD display panel and an input unit including hard keys such as a start key and numeric keys. The operation unit 104 receives (accepts) an instruction to execute a function of the MFP 100 from a user.

A scanner 105 converts a reading signal into electric data (read data) through photoelectric conversion, the reading signal being obtained by optically reading an original fed from an automatic document feeder (ADF) or placed on an original platen. The scanner 105 includes a reading mechanism such as the original platen, a light source for applying light to the original such as an LED, an image sensor that receives light reflected from the original, a carriage having the light source and the image sensor mounted thereon, and a motor for performing control so as to drive the carriage. An image processing circuit 106 includes a large-capacity image memory, an image rotation circuit, a resolution scaling circuit, MH, MR, MMR, JBIG and JPEG encoding/decoding circuits, and is configured to execute various types of image processing operations such as shading, trimming and masking. A hard disk 108 is a large-capacity storage medium that can be connected to the MFP 100 with an interface that conforms to a standard such as SCSI or IDE. A network line interface (I/F) 109 connects a network line and the MFP 100. A telephone line interface 110 connects a telephone line and the MFP 100. A printer 107 performs printing on a printing medium such as printing paper based on read data generated by the scanner 105 or image data acquired from an external PC or the like via the network line I/F 109. The printer 107 performs printing on the printing medium by a printing method such as an inkjet printing method or an electrophotographic printing method. The printer 107 includes a printing mechanism including a printing head, an ink tank, a carriage and the like in the case of the inkjet printing method, and includes a printing mechanism including a photosensitive drum, a beam optical system and the like in the case of the electrophotographic printing method.

The CPU 101, the ROM 102, the RAM 103, the operation unit 104, the hard disk 108, the network line I/F 109 and the telephone line I/F 110 are connected via a system bus 111 so as to be capable of communication with each other. Likewise, the scanner 105, the image processing circuit 106 and the printer 107 are connected via a high-speed image bus 112 so as to be capable of communication with each other, the high-speed image bus 112 being configured to be capable of transferring image data at a high speed. A bus bridge 113 connects the system bus 111 and the high-speed image bus 112, and converts data structures between the two buses.

FIG. 1B is a diagram showing an example of a login screen of the MFP 100. The login screen is displayed on the display unit of the operation unit 104 shown in FIG. 1A. The user performs a login operation to use the MFP 100 by inputting a user name and a password on the login screen shown in FIG. 1B and selecting an “ok” button.

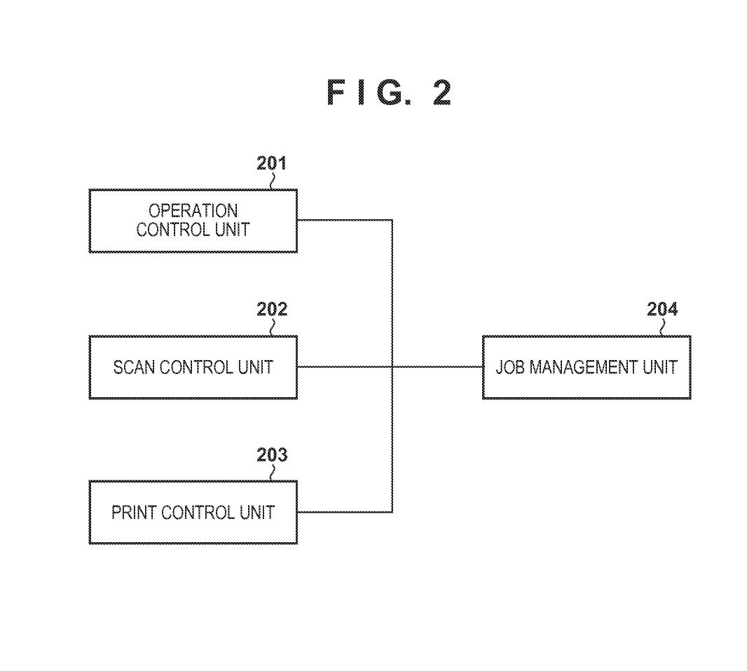

FIG. 2 is a diagram showing a block configuration for managing job history. The blocks shown in FIG. 2 are implemented by, for example, the CPU 101 executing a program. If the MFP 100 executes a job relating to each function, the MFP 100 stores and manages the job in execution history (job history). The configuration for managing job history includes an operation control unit 201, a scan control unit 202, a print control unit 203 and a job management unit 204. The operation control unit 201 controls the operation unit 104, and for example, outputs a function execution instruction received from the user via the operation unit 201 to the scan control unit 202 or the print control unit 203. The scan control unit 202 performs control so as to drive of the reading mechanism included in the scanner 105 in response to an instruction to execute the scan function. Likewise, the print control unit 203 performs control so as to drive the printing mechanism included in the printer 107 in response to an instruction to execute the print function. Although not shown, other control units may be included such as those for executing the send (transmission) function and the fax function that can be executed by the MFP 100. The job management unit 204 manages jobs such as scan jobs and print jobs. To be specific, for example, after execution of a job, the job management unit 204 saves the job in job history together with the date and time at which the job was executed and the result of execution of the job. Also, the job management unit 204 performs queuing of jobs. Specifically, for example, if there is a job that is not immediately executed (a reserved print job, which will be described later), the job management unit 204 saves the job in a queue together with attribute information such as the execution deadline.

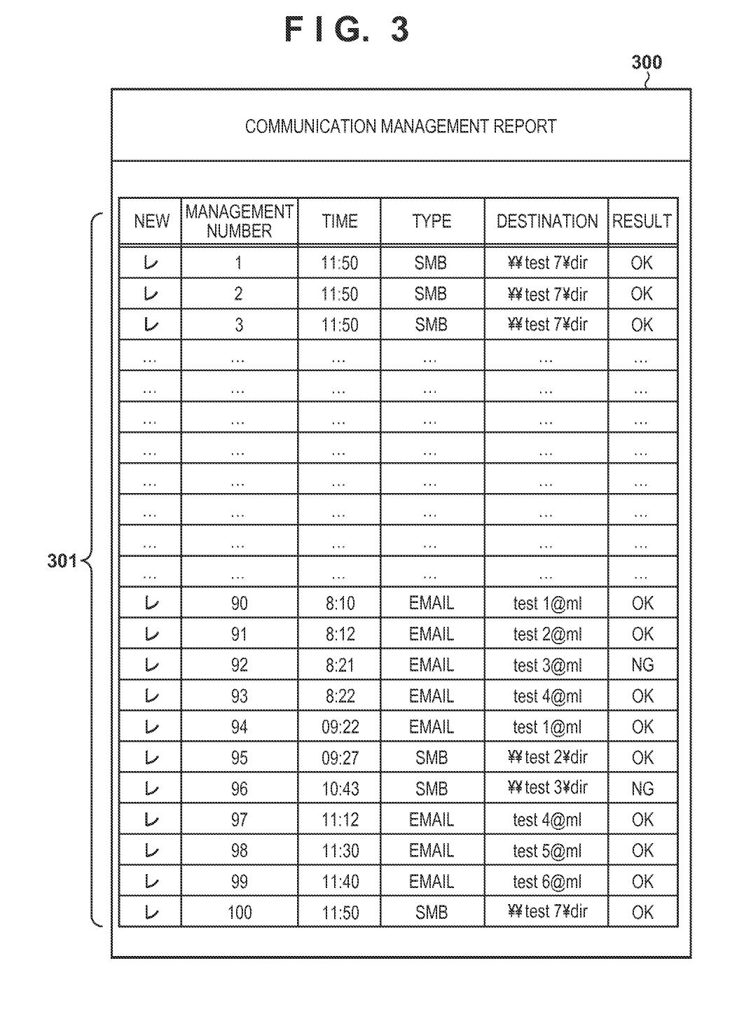

FIG. 3 is a diagram showing an example of a communication management report 300. The communication management report 300 is generated by the job management unit 204. For example, in a job list display area 301, a history of completed jobs of the transmission/reception service (send function or the like) is displayed. As shown in FIG. 3, information including the time at which each job was executed, the job type, the transmission destination address and the result of execution is associated with the management number for identifying each job. The job management unit 204 generates a communication management report 300 as shown in FIG. 3 if a predetermined number of job history entries are accumulated.

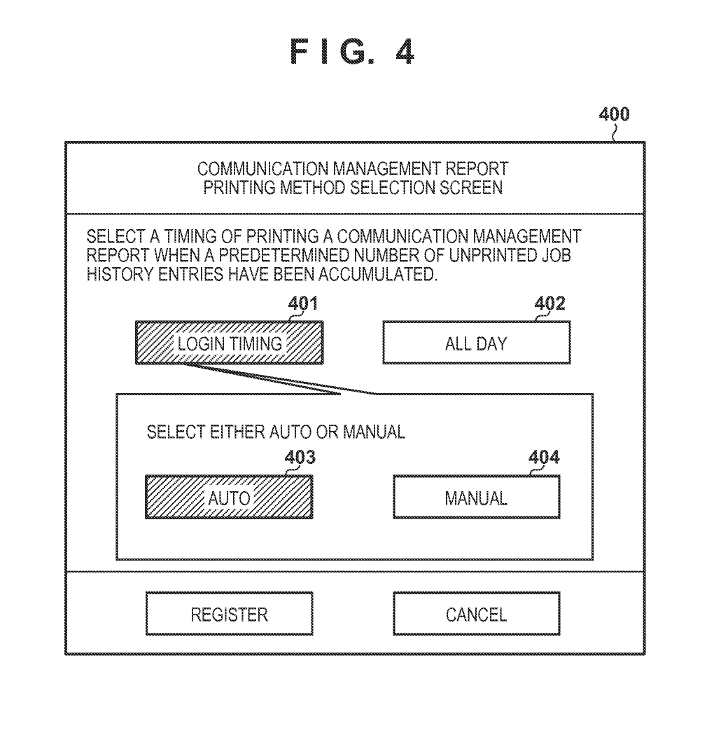

FIG. 4 is a diagram showing an example of a communication management report printing method selection screen 400 used to register the timing (print timing) at which the communication management report 300 is discharged, and the method for discharging the communication management report 300. The printing method selection screen 400 is displayed on the display unit of the operation unit 104. The printing method selection screen 400 may be displayed upon selection of a menu on a main screen of the MFP 100. If a “login timing” button 401 is selected by the user, the communication management report 300 is created when a predetermined number of job history entries (for example, 100 entries) are accumulated as job history, and the communication management report 300 is printed after the user logs in. If an “all day” button 402 is selected by the user, the communication management report 300 is created when a predetermined number of job history entries (for example, 100 entries) of the transmission/reception service are accumulated, and is printed at that time.

An “auto” button 403 and a “manual” button 404 can be selected only if the “login timing” button 401 is selected. If the “auto” button 403 is selected by the user, the communication management report 300 is printed automatically after a user login. If the “manual” button 404 is selected by the user, after a user login, a pop-up screen 800, which will be described later, is displayed on the display unit of the operation unit 104, and the communication management report 300 is printed after a print instruction is received from the user.

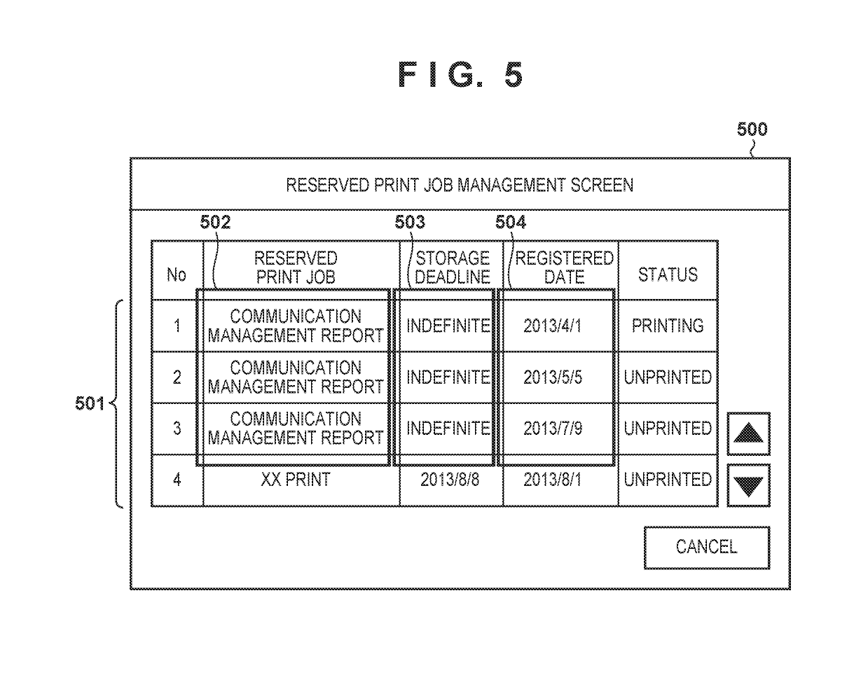

FIG. 5 is a diagram showing a reserved print job management screen 500 displayed when the “login timing” button 401 shown in FIG. 4 is selected. As used herein, “reserved print job” refers to a print job that does not immediately perform printing and thus is stored so as to later perform printing. The fact that the “login timing” button 401 has been selected means that the communication management report 300 is printed after a user login. That is, even if a predetermined number of print jobs are accumulated, printing cannot be started until a login operation is performed by the user, and thus the job is stored (registered) as a reserved print job. In a job list display area 501, reserved print jobs as explained above are registered. Hereinafter, in particular, a print job that is reserved so as to print the communication management report 300 will be referred to as a reserved communication management report job 502.

Storage deadline 503 indicates the deadline by which each reserved print job is stored. In particular, “indefinite” written under the storage deadline 503 indicates that no limit is set to the storage deadline of the print job for printing the communication management report 300, and thus the job is not deleted by expiration of the deadline. Registered date 504 indicates the date and time (saved time) at which each reserved communication management report job 502 was registered as a reserved print job.

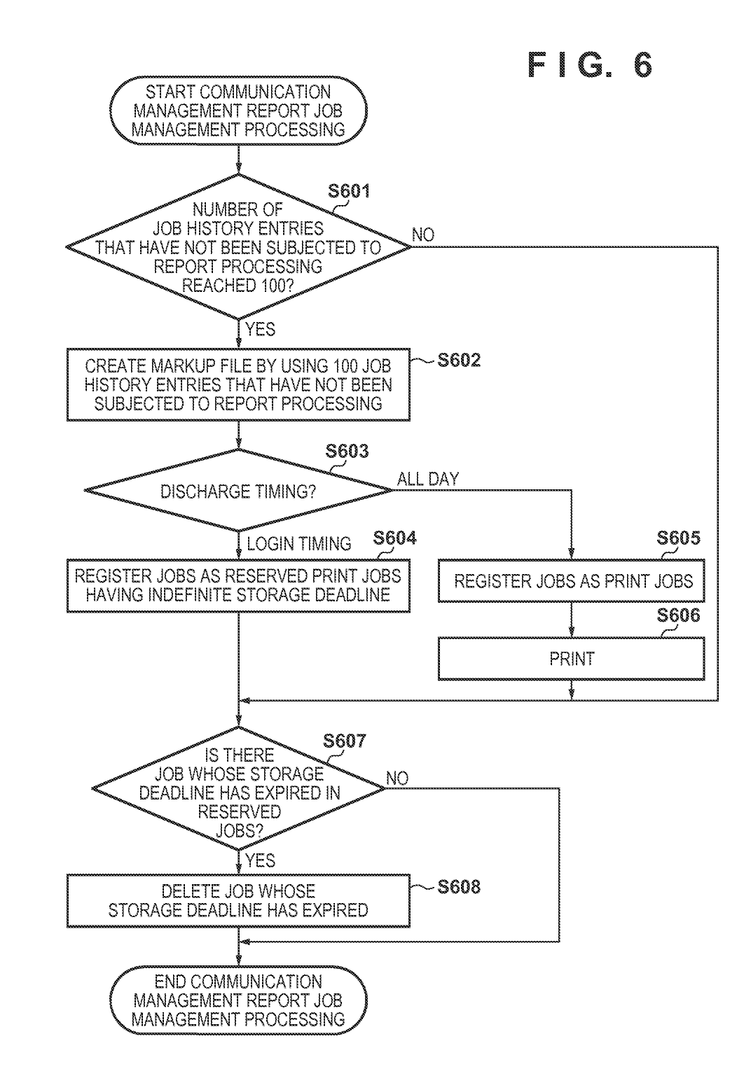

FIGS. 6A and 6B are flowcharts illustrating processing of the communication management report 300. This processing is implemented by, for example, the CPU 101 reading a program from the ROM 102 into the RAM 103 and executing the program.

The CPU 101 determines whether or not a predetermined number of job history entries (for example, 100 entries) of the transmission/reception service have been accumulated (S601). If it is determined in S601 that a predetermined number of job history entries have not been accumulated, the processing proceeds to S607. If, on the other hand, it is determined in S601 that a predetermined number of job history entries have been accumulated, the processing proceeds to S602.

In S602, the CPU 101 creates a markup file by using, for example, 100 job history entries that have been accumulated, and the processing proceeds to S603. As used herein, the markup file is a text file in which a designation indicating the design specification of printouts is written.

In S603, the CPU 101 determines a print (discharge) timing. To be specific, the CPU 101 determines whether the “login timing” button 401 has been selected or the “all day” button 402 been selected on the communication management report printing method selection screen 400. If it is determined that the “login timing” button 401 has been selected, the jobs are registered as reserved communication management report jobs 502 with “indefinite” written in the storage deadline 503 (S604), and the processing proceeds to S607. The reserved print job management screen 500 shown in FIG. 5 shows a list of jobs registered in S604.

If, on the other hand, it is determined in S603 that the “all day” button 402 has been selected, the jobs are registered as normal print jobs rather than as reserved print jobs (S605). Then, the CPU 101 executes the print jobs for printing the communication management report 300 registered as normal print jobs in S605 (S606), and the processing proceeds to S607.

In S607, the CPU 101 determines whether or not there is a job whose storage deadline 503 has expired in the reserved print jobs registered and managed as shown in FIG. 5. If it is determined that there is a job whose storage deadline 503 has expired, in S608, the CPU 101 deletes the job from the registered jobs, and ends the processing shown in FIG. 6. If, on the other hand, it is determined that there is no job whose storage deadline 503 has expired, the CPU 101 ends the processing shown in FIG. 6.

In the present embodiment, as shown in FIG. 6, if a predetermined number of job history entries are accumulated, a print job for printing the communication management report 300 in the form of a markup file is generated. Then, if the “login timing” button 401 is selected on the communication management report printing method selection screen 400, the generated print job is registered as a reserved communication management report job 502. In the foregoing description, the reserved communication management report jobs 502 are registered as having “indefinite” written in the storage deadline 503, but may be registered as having any available deadline written in the storage deadline 503.

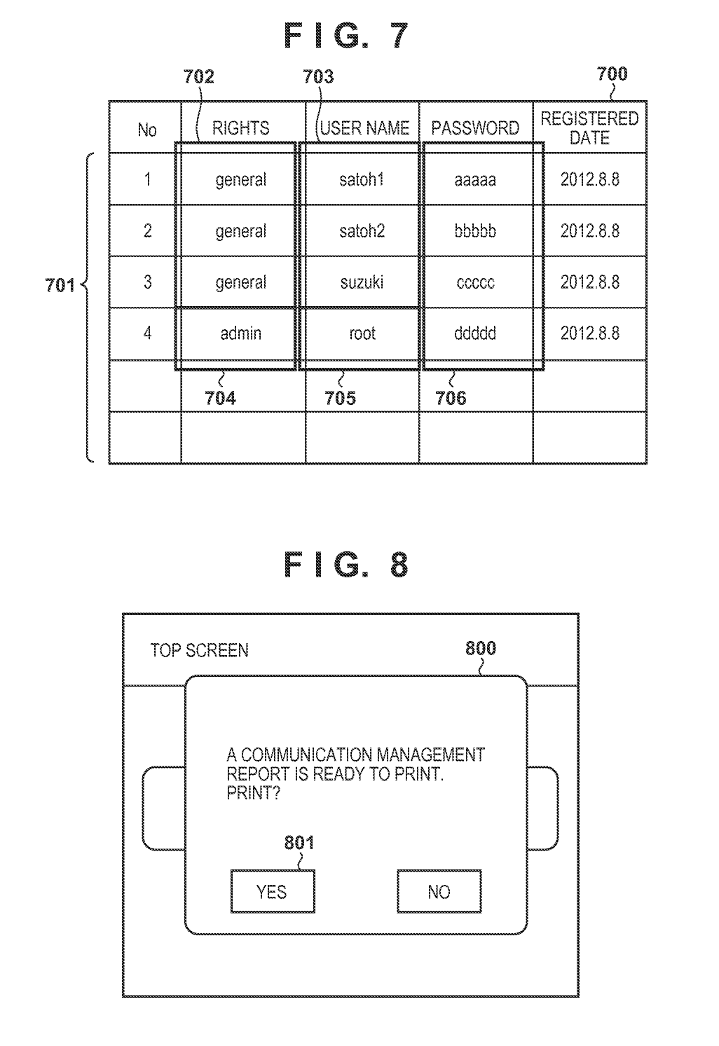

FIG. 7 is a diagram showing an example of a login management table 700 for managing users who log in. The login management table 700 is stored, for example, in the RAM 103, and is referred to for the user information (user name and password) input through a login operation by a user. In FIG. 7, in an area 701, information regarding four users is registered, and the information is referred to when they perform a login operation.

Rights 702 is information indicating a user who can log in with general rights. Hereinafter, a user having general rights will be referred to as a general user. Rights 704 is information indicating a user who can log in with administrative rights. Hereinafter, a user having administrative rights will be referred to as an admin user. The rights of a general user to operate the MFP has a lower level than that of the administrator, and generally, a large number of users are registered as general users. On the other hand, the rights of an admin user to operate the MFP has a higher level than that of the general user, and thus the admin user can, for example, change the MFP equipment settings, print reserved communication management report jobs 502, and the like. For this reason, generally, a limited number of users are registered as admin users. That is, in the present embodiment, the communication management report 300 is an example of a printout for an administrator, and the reserved communication management report job 502 is an example of a print job for an administrator.

User name 703 indicates a user name treated as a general user, and user name 705 indicates a user name treated as an admin user. The user names 703 and 705 are also used as identification information for identifying users. Login operations using user names not registered in the login management table 700 are denied. Password 706 is a character string used to verify user identity, and the character string only known to a user is registered in the login management table 700 in association with the user name. The CPU 101 determines whether or not a password input together with a user name during login authentication of the MFP 100 matches the user name and the password that are registered in the login management table 700. If it is determined in this step that the input user name and password match the registered user name and password, the operator performing the login operation is identified as having the user name, and is authenticated to log in.

In FIG. 7, the passwords 706 are indicated by character strings representing the content of the passwords, but in order to maintain security, the passwords are each indicated as a string of asterisks such as “****” when displayed on the display unit for the user. Also, in FIG. 7, the general users and the admin user have different user names, but the user name may be the same. For example, a case is conceivable in which a user having administrative rights logs into the MFP 100 by using general rights so as to perform a normal task. In this case, the same user name is used for “general user” and “admin user”.

FIG. 8 is a diagram showing an example of a screen for receiving an instruction to print reserved communication management report jobs 502 from a user. A screen 800 is displayed by popping up on the display unit of the operation unit 104 if the “manual” button 404 is selected on the communication management report printing method selection screen 400 shown in FIG. 4 after login of the user. If a “yes” button 801 is selected on the screen 800 by the user, the reserved communication management report jobs 502 managed in the reserved print job management screen 500 shown in FIG. 5 are printed.

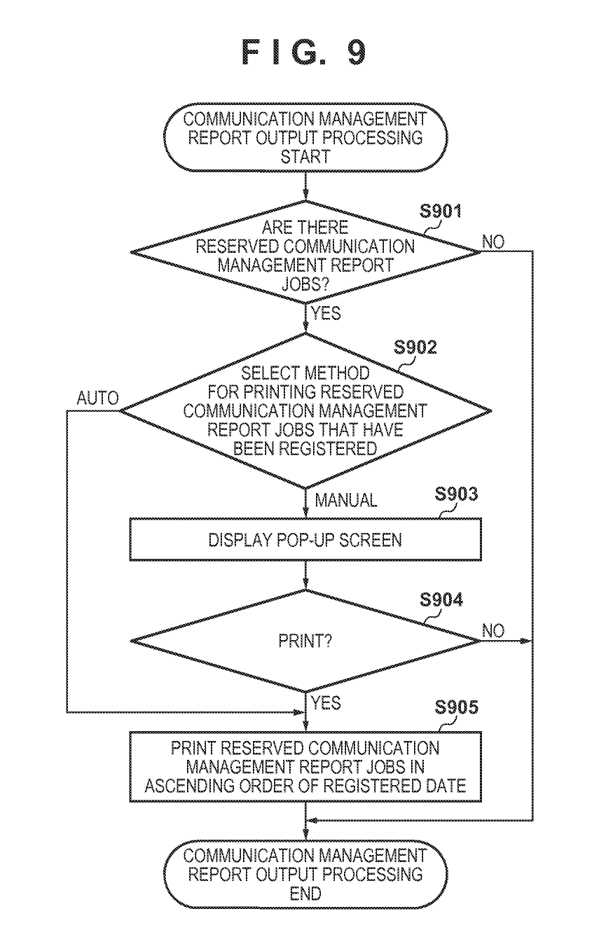

FIG. 9 is a flowchart illustrating print processing for printing the reserved communication management report jobs 502. This processing is implemented by, for example, the CPU 101 reading a program from the ROM 102 into the RAM 103 and executing the program.

The CPU 101 determines whether or not there are reserved communication management report jobs 502 in the jobs managed in the reserved print job management screen 500 (S901). If it is determined in S901 that there is no reserved communication management report job 502, the CPU 101 ends the processing shown in FIG. 9. If, on the other hand, it is determined in S901 that there are reserved communication management report jobs 502, the processing proceeds to S902.

In S902, the CPU 101 determines whether the “auto” button 403 has been selected or the “manual” button 404 has been selected on the communication management report printing method selection screen 400. If it is determined in S902 that the “auto” button 403 has been selected, the processing proceeds to S905. If, on the other hand, it is determined in S902 that the “manual” button 404 has been selected, the screen 800 shown in FIG. 8 is displayed on the display unit by popping up (S903), and the processing proceeds to S904.

In S904, the CPU 101 determines whether or not the “yes” button 801 has been selected on the screen 900 (selection has been made to perform printing). If it is determined in S904 that selection has been made to perform printing, the processing proceeds to S905. If, on the other hand, it is determined that selection has been made to not perform printing, the CPU 101 ends the processing shown in FIG. 9. In S905, the CPU 101 prints the reserved communication management report jobs 502 in ascending order of the registered date 504, and thereafter ends the processing shown in FIG. 9.

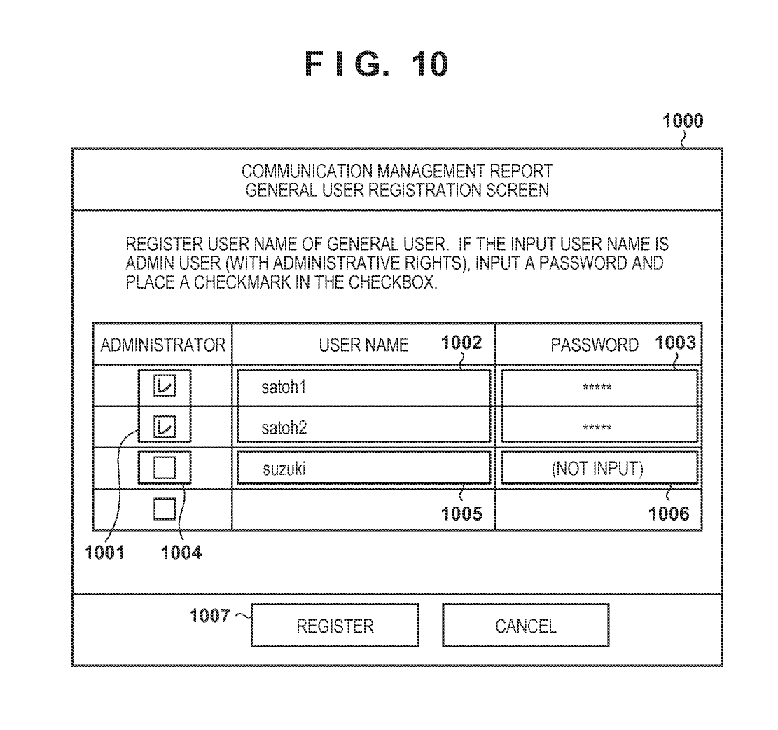

FIG. 10 is a diagram showing an example of a general user registration screen 1000 for registering a general user who can print the reserved communication management report jobs 502. Registration of a general user is performed on the general user registration screen 1000 by the admin user.

In the present embodiment, there are two cases in which a general user can print the reserved communication management report jobs 502. One is the case where an administrator having a user name that allows for login as “admin user” logs in by using another user name as “general user” held to perform a normal task or the like. The other case is where the administrator permits a general user to print the reserved communication management report jobs 502.

An administrator check area 1001 on the general user registration screen 1000 indicates, if a checkmark is placed, an administrator having “admin user” logs in with a user name as “general user” held to perform a normal task or the like. User name 1002 indicates a user name as “general user”. Password 1003 is a password associated with the user name 1002. In the present embodiment, if a checkmark is placed in the administrator check area 1001, a request for registering the password 1003 is issued. As will be described later with reference to FIG. 10, if a “register” button 1007 is selected, and a user name 1002 and a password 1003 are registered, check processing for determining whether or not the user name and the password match the user name and the password that are registered in the login management table 700 by referring to the login management table 700 is performed.

As shown in FIG. 10, no checkmark is placed in an administrator check area 1004. That is, the general user not having a checkmark in the administrator check area 1004 is a general user permitted by the administrator. User name 1005 indicates the user name of the general user. Password 1006 is associated with the user name 1005, but because a checkmark is not placed in the administrator check area 1004, a request for registering a password is not issued.

As described above, in the present embodiment, the user who can print the communication management report 300 is not limited to “admin user”, and a general user registered in the general user registration screen 1000 can also print the communication management report 300. The general user may be the same as “admin user”, or may be a user permitted by the admin user.

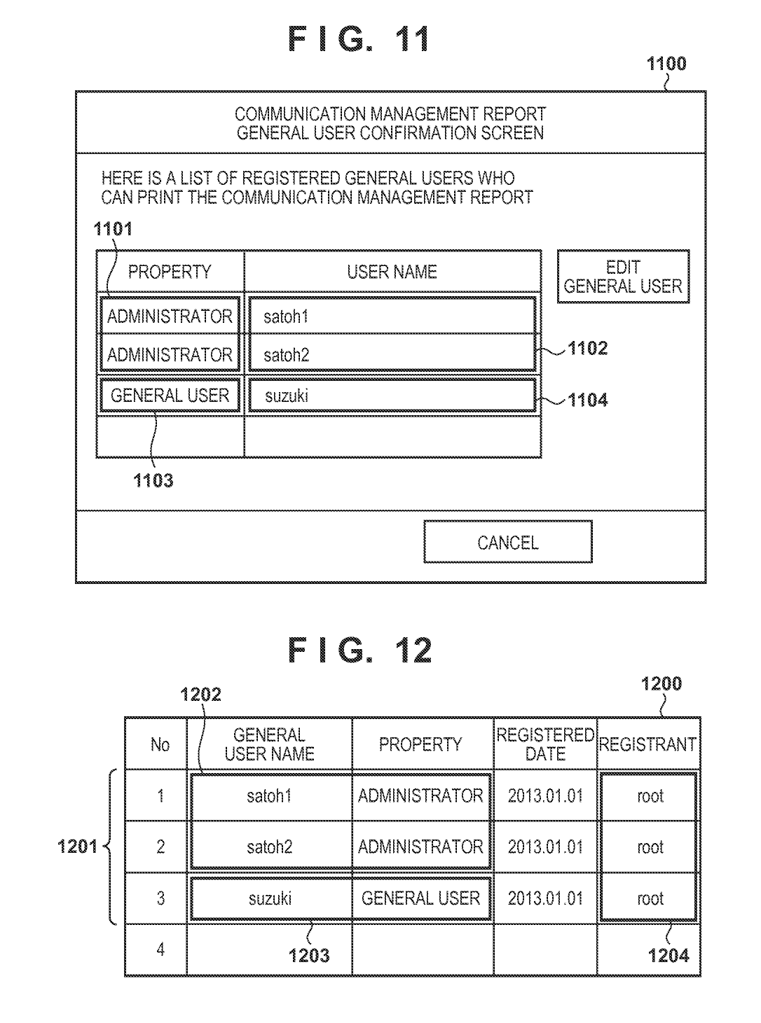

FIG. 11 is a general user confirmation screen 1100 for confirming the general user who can print the reserved communication management report jobs 502. The general user confirmation screen 1100 is displayed if information input on the general user registration screen 1000 is successfully registered. Property 1101 and property 1103 correspond to the type of general user on the general user registration screen 1000. As indicated by the property 1101, if a general user having a checkmark in the administrator check area 1001 on the general user registration screen 1000 is successfully registered, the user is registered with an attribute of “administrator”. As indicated by the property 1103, if a general user not having a checkmark in the administrator check area 1004 on the general user registration screen 1000 is successfully registered, the user is registered with an attribute of “general user”. In user name 1102, a user name input in the user name 1002 is displayed as a result of successful registration. Also, in user name 1104, a user name input in the user name 1005 is displayed as a result of successful registration.

FIG. 12 is a diagram showing a general user table 1200 corresponding to the state of a memory in which the information registered on the general user registration screen 1000 is saved. It can also be said that FIG. 12 is the state of a memory that is referred to by the general user confirmation screen 1100. Items 1201 correspond to three pieces of information input on the general user registration screen 1000. Areas 1202 correspond to the administrator check area 1001 and the user name 1002 on the general user registration screen 1000. The areas 1202 also correspond to the property 1101 and the user name 1102. Area 1203 corresponds to the administrator check area 1004 and the user name 1005 on the general user registration screen 1000. The area 1203 also corresponds to the property 1103 and the user name 1104. Areas 1204 show a user name “root” as “admin user”, that is, the administrator who registered the information in the general user table 1200.

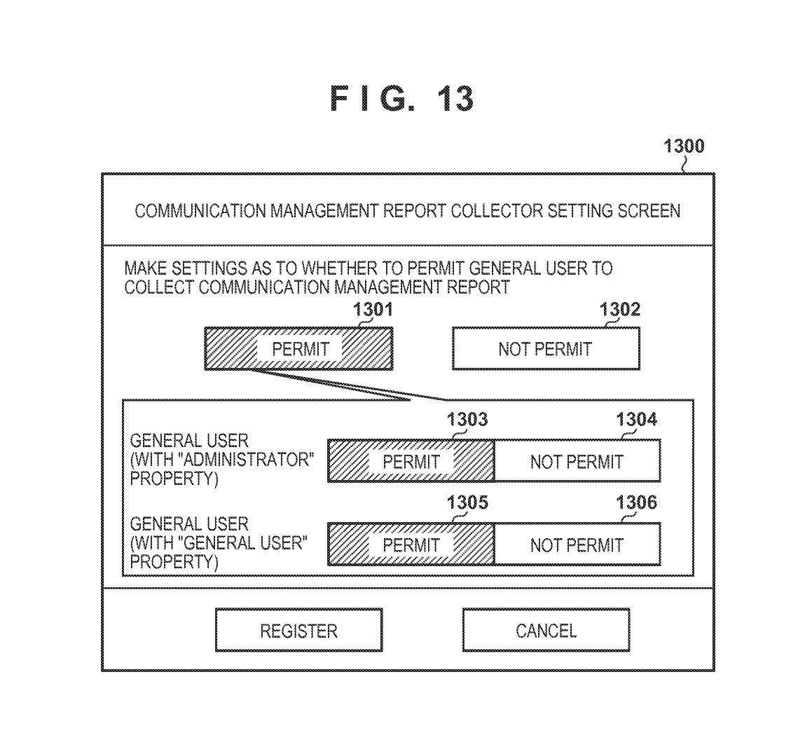

FIG. 13 is a diagram showing a communication management report collector setting screen 1300 for setting whether or not to permit a general user to perform a printing operation of the communication management report 300 (including a collecting operation of the printout). If a “permit” button 1301 is selected by the user, “general user” is permitted to perform print processing of the reserved communication management report jobs 502 after login as “general user”. If a “not permit” (disallowed) button 1302 is selected by the user, “general user” is not permitted to perform print processing of the reserved communication management report jobs 502 after login as “general user”.

If a “permit” button 1303 is selected by the user, “administrator” indicated in the area 1202 is permitted to perform print processing of the reserved communication management report jobs 502 after the user having “administrator” has logged in as “general user”. If a “not permit” (disallowed) button 1304 is selected by the user, “administrator” indicated in the area 1202 is not permitted to perform print processing of the reserved communication management report jobs 502 after the user having “administrator” has logged in as “general user”. A “permit” button 1305 permits “general user” indicated in the area 1203 to perform print processing of the reserved communication management report jobs 502 after the user having “general user” has logged in as “general user”. If a “not permit” (disallowed) button 1306 is selected by the user, “general user” indicated in the area 1203 is no permitted to perform print processing of the reserved communication management report jobs 502 after the user having “general user” has logged in as “general user”.

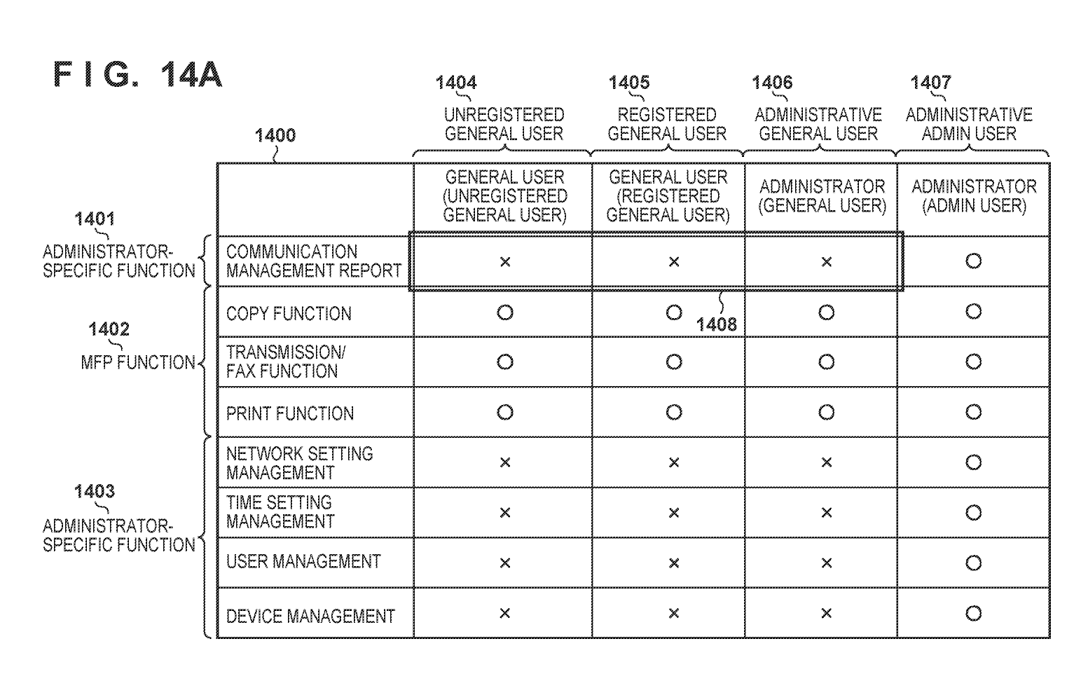

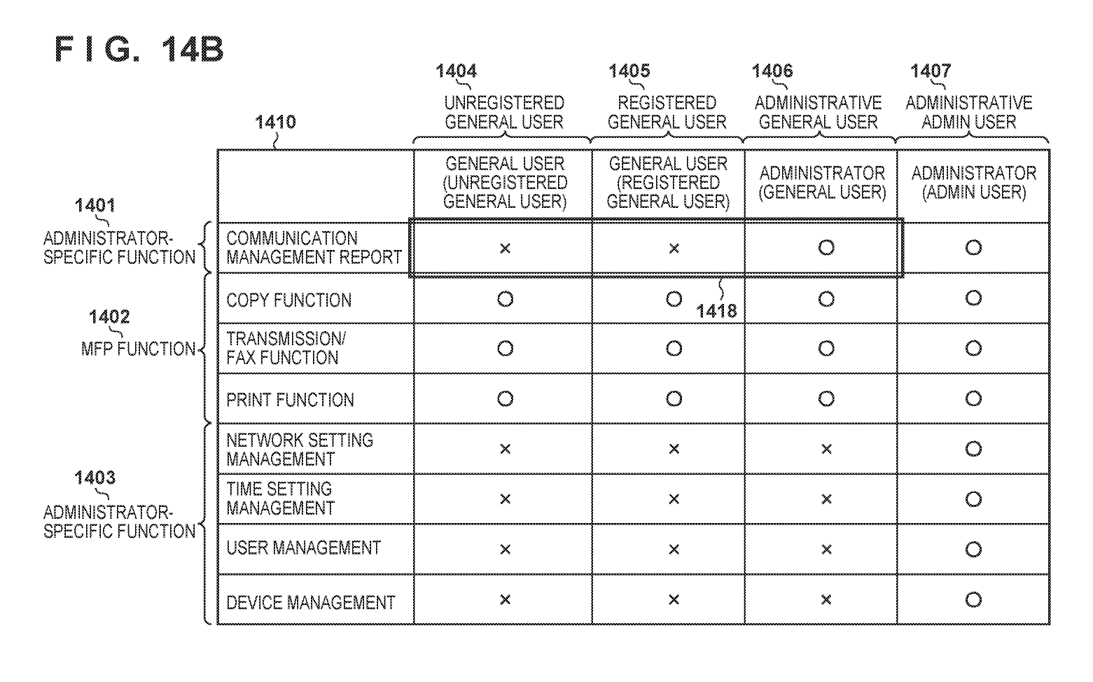

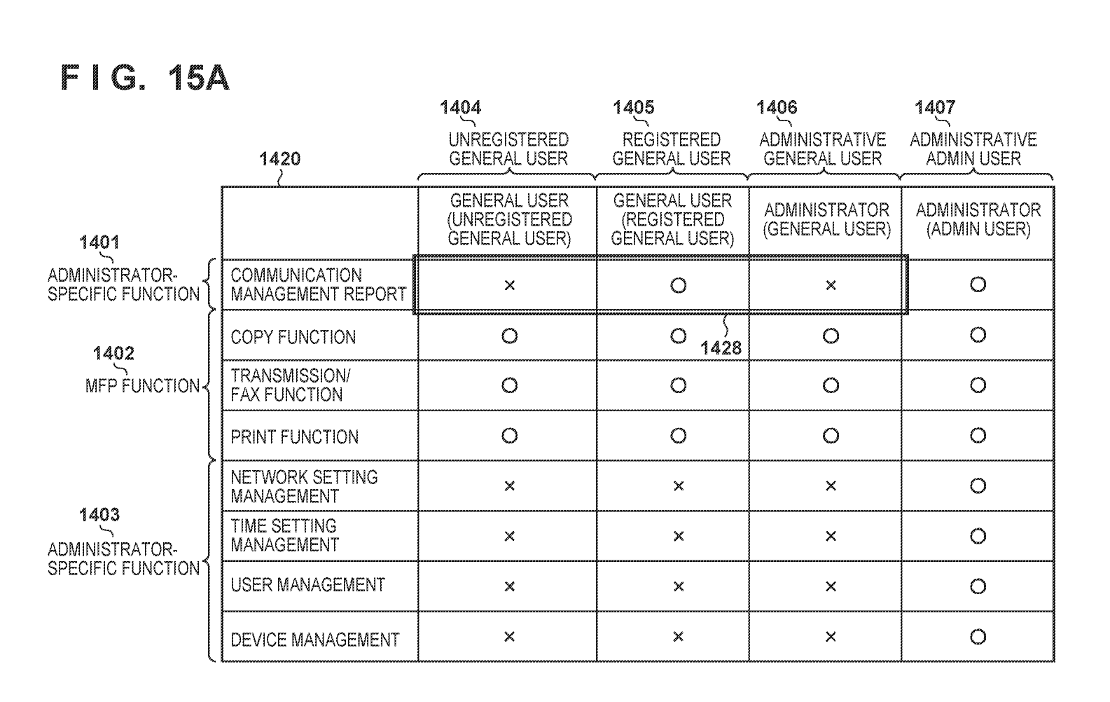

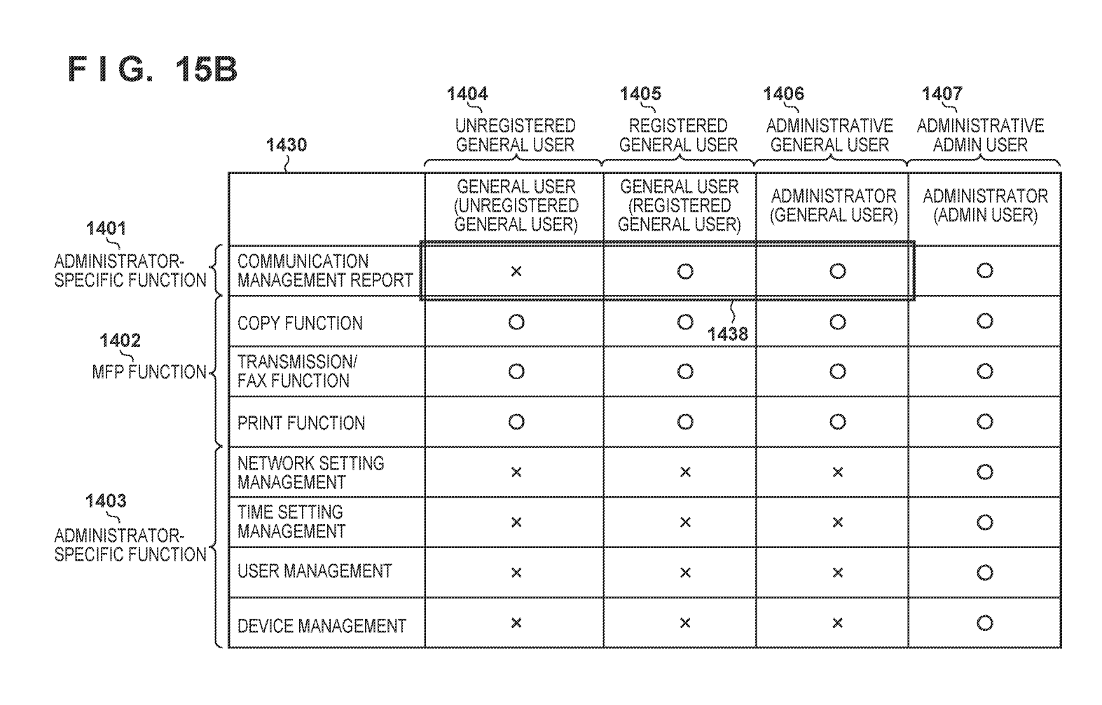

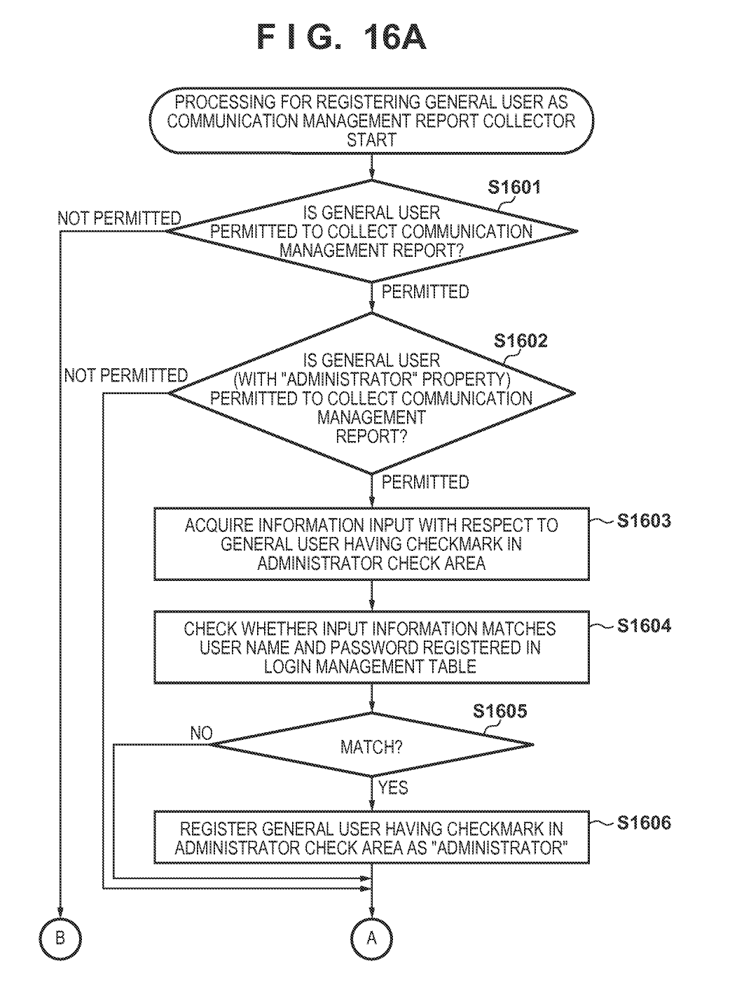

FIGS. 14A, 14B, 15A and 15B are diagrams each showing a list of rights to use the functions provided by the MFP 100 for each of four different types of login users. Also, FIGS. 14A, 14B, 15A and 15B show how the rights changes by combinations of settings of the four buttons on the communication management report collector setting screen 1300.

Each diagram shows general functions that can be executed by either “general user” or “administrator” and administrator functions that can be executed only by “administrator” from among the functions provided by the MFP 100. Administrator-specific function 1401 includes a communication management report function, and is normally treated as a function targeted for an administrator. However, in the present embodiment, switching is possible such that even “general user” can execute the communication management report function. MFP function 1402 includes a copy function, a transmission/fax function and a print function, and these functions are treated as general functions that can be executed either by “general user” or “administrator”. Administrator-specific function 1403 includes a network setting management function, a time setting management function, a user management function and a device management function, and these functions are treated as administrator functions that can be executed only by “administrator”.

Four different types of login users will be described. Unregistered general user 1404 indicates a general user who is not registered on the general user registration screen 1000. Registered general user 1405 indicates a general user registered with an attribute of “general user”, without a checkmark in the administrator check area 1004. Administrative general user 1406 indicates a general user registered with an attribute of “administrator”, with a checkmark in the administrator check area 1004. Administrative admin user 1407 indicates an admin user. The administrative admin user 1407 can execute all of the functions provided by the MFP 100 irrespective of the combinations of the settings of the four buttons on the communication management report collector setting screen 1400.

FIG. 14A is a diagram showing a list of rights to use the functions provided by the MFP 100 per login user in the case where a permission to print the communication management report 300 is not given to a user who logs in as “general user”. The conditions shown in rights list 1400 correspond to the case where the “not permit” button 1302, which does not permit “general user” to perform printing, has been selected on the communication management report collector setting screen 1300. Each circle written in rights 1408 indicates that a permission to print the communication management report 300 is given, and each cross indicates that a permission to print the communication management report 300 is not given. In FIG. 14A, none of the unregistered general user 1404, the registered general user 1405 and the administrative general user 1406 is permitted to print the communication management report 300.

FIG. 14B is a diagram showing a list of rights to use the functions provided by the MFP 100 per login user in the case where a permission to print the communication management report 300 is given to an administrator who has logged in as “general user”. The conditions shown in rights list 1410 correspond to the case where the “permit” button 1301, the “permit” button 1303 and the “not permit” button 1306 have been selected on the communication management report collector setting screen 1300. Referring to rights 1418, the unregistered general user 1404 and the registered general user 1405 are not permitted to print the communication management report 300, but the administrative general user 1406 is permitted to print the communication management report 300.

FIG. 15A is a diagram showing a list of rights to use the functions provided by the MFP 100 per login user in the case where a permission to print the communication management report 300 is given to a general user who has logged in as “general user”. The conditions shown in rights list 1420 correspond to the case where the “permit” button 1301, the “not permit” button 1304 and the “permit” button 1305 have been selected on the communication management report collector setting screen 1300. Referring to an area 1428, the unregistered general user 1404 and the administrative general user 1406 are not permitted to print the communication management report 300, but the registered general user 1405 is permitted to print the communication management report 300.

FIG. 15B is a diagram showing a list of rights to use the functions provided by the MFP 100 per login user in the case where a permission to print the communication management report 300 is given to a general user and an administrator who have logged in as “general user”. The conditions shown in rights list 1430 correspond to the case where the “permit” button 1301, the “permit” button 1303 and the “permit” button 1305 have been selected on the communication management report collector setting screen 1300. Referring to an area 1438, the unregistered general user 1404 is not permitted to print the communication management report 300, but the registered general user 1405 and the administrative general user 1406 are permitted to print the communication management report 300. As compared with the rights list 1400, it can be seen that the number of general users permitted to print the communication management report 300 is increasing in the rights list 1410, the rights list 1420 and the rights list 1430.

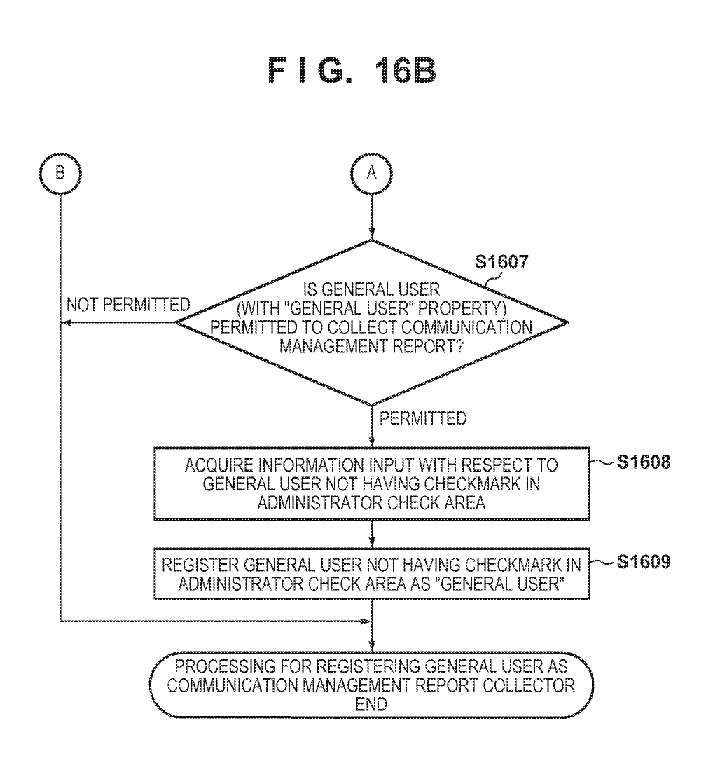

FIGS. 16A and 16B are flowcharts illustrating registration processing for registering a general user who performs print processing of the reserved communication management report jobs 502. This processing is implemented by, for example, the CPU 101 reading a program from the ROM 102 into the RAM 103 and executing the program.

The CPU 101 determines whether or not “general user” is permitted to print the communication management report 300 based on the selection of the buttons on the communication management report collector setting screen 1300 (S1601). If it is determined that the “permit” button 1301 has been selected and “general user” is permitted to print the communication management report 300, the processing proceeds to S1602. If, on the other hand, it is determined in S1601 that the “not permit” button 1302 has been selected and “general user” is not permitted to print the communication management report 300, the processing shown in FIGS. 16A and 16B ends.

In S1602, the CPU 101 determines whether or not “administrator” is permitted to print the communication management report 300 after login as “general user” based on the selection of the buttons on the communication management report collector setting screen 1300. If it is determined in S1602 that the “permit” button 1303 has been selected and “administrator” who has logged in as “general user” is permitted to print the communication management report 300, the processing proceeds to S1603. If, on the other hand, it is determined in S1602 that the “not permit” button 1304 has been selected and “administrator” is not permitted to print the communication management report 300 after login as “general user”, the processing proceeds to S1607.

In S1603, the CPU 101 acquires the information (user name 1002 and password 1003) input with respect to a general user having a checkmark in the administrator check area 1001 on the general user registration screen 1000. In S1604, the CPU 101 executes check processing for determining whether or not the input user name and password match the user name and password registered in the login management table 700 (S1604). If it is determined as a result of the check processing performed in S1604 that the input user name and password match the user name and password registered in the login management table 700 (S1605), the processing proceeds to S1606. If, on the other hand, it is determined in S1605 that the input user name and password do not match the user name and password registered in the login management table 700, the processing proceeds to S1607.

In S1606, the CPU 101 registers the user name acquired in S1603 together with “administrator” information determined as the property of the user name, the registered date and the registrant in the general user table 1200, and ends the processing shown in FIGS. 16A and 16B.

In S1607, the CPU 101 determines whether or not “general user” is permitted to print the communication management report 300 after login as “general user” based on the selection of the buttons on the communication management report collector setting screen 1300. If it is determined in S1607 that the “permit” button 1305 has been selected and “general user” is permitted to print the communication management report 300 after login as “general user”, the processing proceeds to S1608. If, on the other hand, it is determined in the check processing performed in S1607 that the “not permit” button 1306 has been selected and “general user” is not permitted to print the communication management report 300 after login as “general user”, the processing shown in FIGS. 16A and 16B ends. In S1608, the CPU 101 acquires the information (user name 1005 and password 1006) input with respect to a general user not having a checkmark in the administrator check area 1004 on the general user registration screen 1000. In S1609, the CPU 101 registers the user name acquired in S1608 together with “general user” information determined as the property of the user name, the registered date and the registrant in the general user table 1200, and ends the processing shown in FIGS. 16A and 16B.

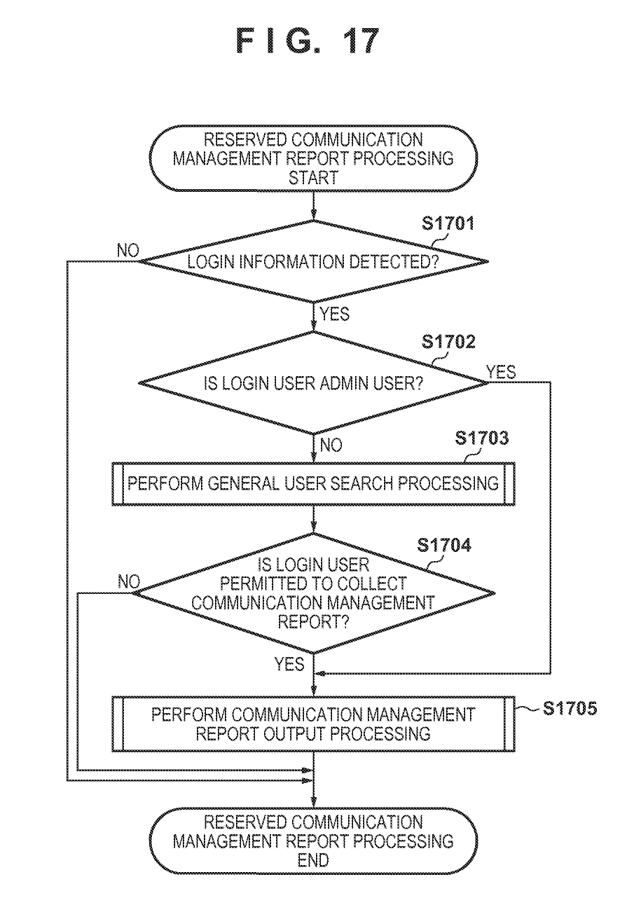

FIG. 17 is a flowchart illustrating processing for controlling the printing of the communication management report 300 based on the reserved communication management report jobs 502 after user login. This processing is implemented by, for example, the CPU 101 reading a program from the ROM 102 into the RAM 103 and executing the program.

The CPU 101 determines whether or not login information (user information) input on the login screen of the MFP 100 has been detected (S1701). If it is determined in S1701 that login information has been detected, the processing proceeds to S1702. If, on the other hand, it is determined in S1701 that login information has not been detected, the processing shown in FIG. 17 ends.

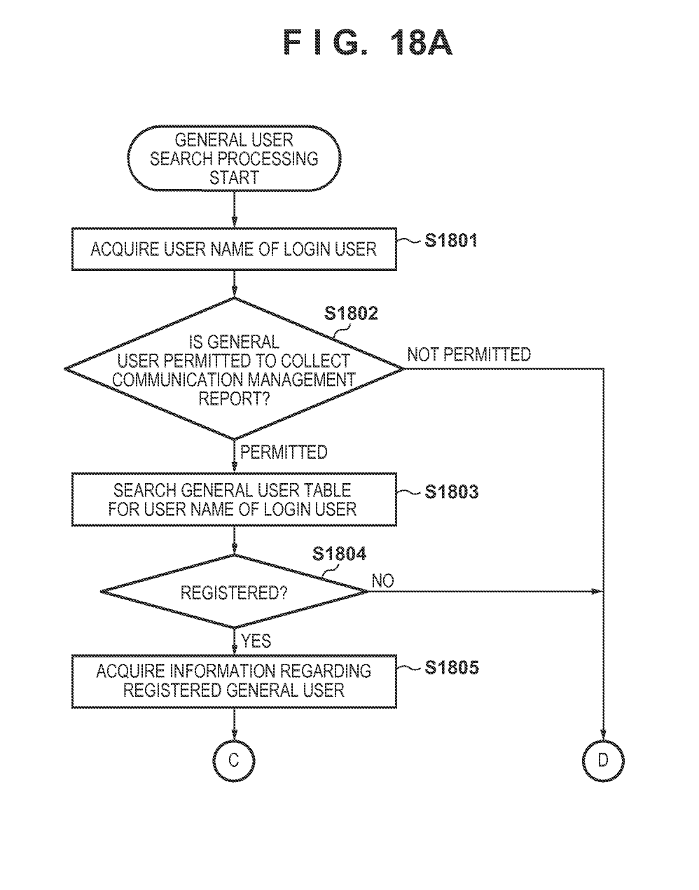

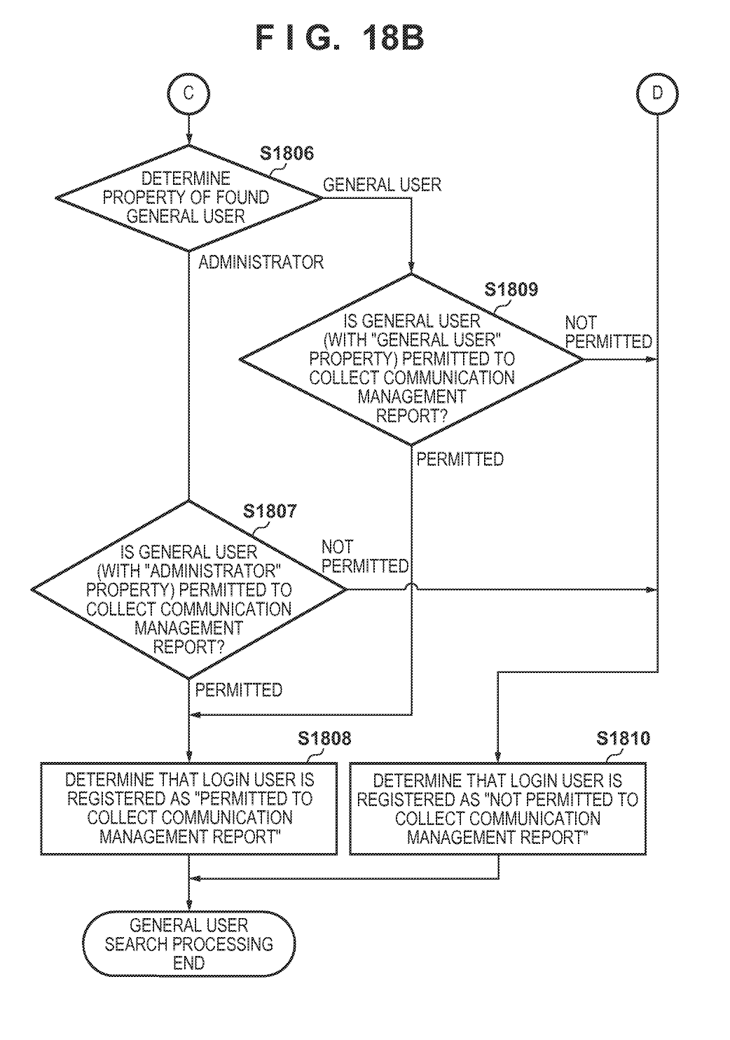

In S1702, the CPU 101 determines whether or not the user who logged in has “admin” in the rights 704 by referring to the login management table 700 shown in FIG. 7. If it is determined in S1702 that the user who logged in has “admin” in the rights 704, the processing proceeds to S1705. If, on the other hand, it is determined in S1702 that the user who logged in does not have “admin” in the rights 704, the processing proceeds to S1703. In S1703, general user search processing is executed so as to check whether or not the user who logged in as “general user” is permitted to print the communication management report 300. The processing of S1703 will be described later with reference to FIGS. 18A and 18B.

After the processing of S1703, in S1704, the CPU 101 determines whether or not the user who logged in is permitted to print the communication management report 300. If it is determined in S1704 that the user who logged in is permitted to print the communication management report 300, the processing proceeds to S1705. If, on the other hand, it is determined in S1704 that the user who logged in is not permitted to print the communication management report 300, the processing shown in FIG. 17 ends. In S1705, the CPU 101 executes communication management report output processing shown in FIG. 9, and then ends the processing shown in FIG. 17.

In the present embodiment, printing of the communication management report 300 is not limited only by a user who has logged in with a user name as “admin user”. That is, the communication management report 300 can be printed even by a user has logged in with a user name as “general user”, as long as the general user is permitted by the system. In other words, it is possible to increase the number of users who can print and collect the communication management report 300, reduce situations in which the communication management report 300 is left on the tray, and prevent leakage of the content of the communication management report 300.

FIGS. 18A and 18B are flowcharts illustrating processing for determining a general user who, after login, performs print processing of the reserved communication management report jobs 502 and prints the communication management report 300. This processing is implemented by, for example, the CPU 101 reading a program from the ROM 102 into the RAM 103 and executing the program.

The CPU 101 acquires the user name of the login user (S1801). Then, in S1802, the CPU 101 determines whether or not “general user” is permitted to print the communication management report 300 based on the selection of the buttons on the communication management report collector setting screen 1300. If it is determined in S1802 that the “permit” button 1301 has been selected and “general user” is permitted to print the communication management report 300, the processing proceeds to S1803. If, on the other hand, it is determined in S1802 that the “not permit” button 1302 has been selected and “general user” is not permitted to print the communication management report 300, the processing proceeds to S1810. In S1810, the CPU 101 determines that the login user in is registered as “not permitted to collect communication management report 300”, and ends the processing shown in FIGS. 18A and 18B.

In S1803, the CPU 101 searches the general user table 1200 for the user name of the login user which was acquired in S1801. Then, in S1804, the CPU 101 determines whether or not the user name of the login user acquired in S1801 is registered in the general user table 1200. If it is determined in S1804 that the user name is registered in the general user table 1200, the CPU 101 acquires information regarding the user name from the general user table 1200 (S1805). If, on the other hand, it is determined in S1804 that the user name is not registered in the general user table 1200, the processing proceeds to S1810.

In S1806, the CPU 101 determines, based on the information acquired in S1805, whether the property information of the general user is “administrator” or “general user”. If it is determined in S1806 that the property of the general user is “administrator”, the processing proceeds to S1807. If, on the other hand, it is determined in S1806 that the property of the general user is “general user”, the processing proceeds to S1809.

In S1807, the CPU 101 determines whether or not the general user whose property is “administrator” is permitted to print the communication management report 300 after login based on the selection of the buttons on the communication management report collector setting screen 1300. If it is determined in S1807 that the “permit” button 1303 has been selected and the general user whose property is “administrator” is permitted to print the communication management report 300, the processing proceeds to S1808. In S1808, the CPU 101 determines that the login user is registered as “permitted to collect communication management report 300”, and ends the processing shown in FIGS. 18A and 18B. If, on the other hand, it is determined in S1807 that the “not permit” button 1304 has been selected and the general user whose property is “administrator” is not permitted to print the communication management report 300, the processing proceeds to S1810.

In S1809, the CPU 101 determines whether or not the general user whose property is “general user” is permitted to print the communication management report 300 after login based on the selection of the buttons on the communication management report collector setting screen 1300. If it is determined in S1809 that the “permit” button 1305 has been selected and the general user whose property is “general user” is permitted to print the communication management report 300, the processing proceeds to S1808. If, on the other hand, it is determined in S1809 that the “not permit” button 1306 has been selected and the general user whose property is “general user” is not permitted to print the communication management report 300, the processing proceeds to S1810.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-075725, filed Apr. 1, 2014, which is hereby incorporated by reference herein in its entirety.

What is claimed is:

1. An image forming apparatus comprising:
an acquiring unit configured to acquire user information of a login user;
a determining unit configured to, in a case where the user information is acquired by the acquiring unit, determine whether or not a permission to execute a print job for an administrator for printing print information for an administrator is given to the user information; and
a print unit configured to, in a case where it is determined by the determining unit that the permission is given, execute the print job for an administrator so as to print the print information for an administrator.

2. The image forming apparatus according to claim 1, further comprising a receiving unit configured to accept the user information on a login screen.

3. The image forming apparatus according to claim 1, further comprising a display unit configured to display a screen for receiving a print instruction indicating whether or not to print the print information for an administrator,
wherein the print unit is configured, upon receiving the print instruction on the screen, execute the print job for an administrator so as to print the print information for an administrator.

4. The image forming apparatus according to claim 1, further comprising a storage unit configured to store a list of user information of users permitted to execute the print job for an administrator,
wherein the determining unit is configured to, in a case where the user information acquired by the acquiring unit is stored in the storage unit, determine that execution of the print job for an administrator is permitted.

5. The image forming apparatus according to claim 1, further comprising a setting unit configured to set a print timing of the print job for an administrator,
wherein the print unit is configured to execute the print job for an administrator so as to print the print information for an administrator in a case where the print timing is set by the setting unit to a timing corresponding to a user login.

6. The image forming apparatus according to claim 5, further comprising:
a generation unit configured to, in a case where the number of job execution history entries reaches a predetermined number, generate the print job for an administrator for printing a file including information regarding the predetermined number of job execution history entries; and
a saving unit configured to save the print job for an administrator generated by the generation unit in a queue in a case where the print timing is set by the setting unit to a timing corresponding to a user login,
wherein the print unit is configured to execute the print job for an administrator saved in the queue so as to print the print information for an administrator.

7. The image forming apparatus according to claim 6,
wherein the print unit is configured to, in a case where a plurality of print jobs for an administrator are saved in the queue, execute the print jobs for an administrator saved in the queue in time order in which the print jobs for an administrator were saved in the queue so as to print the print information for an administrator.

8. A print control method executed by an image forming apparatus, the method comprising:
an acquiring step of acquiring user information of a login user;
a determining step of, in a case where the user information is acquired in the acquiring step, determining whether or not a permission to execute a print job for an administrator for printing print information for an administrator is given to the user information; and
a print step of, in a case where it is determined in the determining step that the permission is given, executing the print job for an administrator so as to print the print information for an administrator.

9. A non-transitory computer-readable storage medium storing a program causing a computer to execute the steps of the print control method according to claim 8.
